(19) United States
(12) Patent Application Publication
(10) Pub. No.: US 2008/0192689 A1
(43) Pub. Date: Aug. 14, 2008

(54) Wireless mesh network system enabling adaptive channel allocation and channel allocation control method in the system

(76) Inventors: Eui-Jik Kim, Suwon-si (KR); Yong-Seok Park, Seongnam-si (KR)

Correspondence Address: ROBERT E. BUSHNELL, 1522 K STREET NW, SUITE 300, WASHINGTON, DC, 20005-1202, US

(21) Appl. No.: 12/068,454

(22) Filed: Feb. 6, 2008

(30) Foreign Application Priority Data
Feb. 12, 2007 (KR) 10-2007-0014292

(51) Int. Cl. H04Q 7/00

(52) U.S. Cl. 370/329

(57) ABSTRACT

A channel allocation control method in a wireless mesh network system in which an adaptive channel allocation is possible, including: determining whether an Ad-hoc Traffic Indication Message (ATIM) packet is received from a transmission node during an ATIM window period after transmission of a beacon; determining whether a received point in time of the ATIM packet is a termination point in time of the ATIM window period when the ATIM Packet is received from the transmission node as a result of the determination; setting an ATIM unit period for a channel negation time of a received node when the received point in time of the ATIM packet is the termination point in ATIM window period as a result of the determination; and terminating the ATIM window after performing the channel negation with the transmission node that transmitted the ATIM packet. The improved wireless mesh network systems also are disclosed.

### CLAIM OF PRIORITY

This application makes reference to, incorporates the same herein, and claims all benefits accruing under 35 U.S.C. §119 from an application for WIRELESS MESH NETWORK SYSTEM ENABLING ADAPTIVE CHANNEL ALLOCATION AND CHANNEL ALLOCATION CONTROL METHOD IN THE SYSTEM earlier filed in the Korean Intellectual Property Office on 12 Feb. 2007 and there duly assigned Serial No. 2007-0014292.

### BACKGROUND OF THE INVENTION

1. Field of the Invention

The present invention relates to a wireless mesh network system, more particularly, an improved wireless mesh network system in which an adaptive channel allocation is possible and a channel allocation control method for the system.

2. Description of Related Art

A multi-channel selection model is considered to improve the performance of a wireless mesh network, and also, research regarding Medium Access Control (MAC) protocol is being conducted.

A multi-channel enables simultaneous communication with a neighboring node without interference. Therefore, it is possible to achieve a relatively greater network throughput than using a single channel.

With regard to this, a protocol that includes one interface for each channel at each node is suggested. This protocol, however, may increase cost.

Also, another protocol that includes two interfaces at each node is suggested. In this instance, one of the interfaces is used for control. That is, one of the interfaces is allocated as a common channel to transmit a channel allocation packet and a control packet such as a request to send (RTS)/clear to send (CTS) and the like. The other interface is switched between channels and used for data exchange.

The protocol with two interfaces is disadvantageous in that a common control channel may deleteriously affects the performance. Specifically, the RTS/CTS exchange process must precede each data transmission. This type of approach, however, may be inappropriate when the number of data channels increases.

Specifically, the contemporary wireless mesh network system using a multi-channel MAC (MMAC) protocol includes a single interface at each node and extensively applies a power saving mechanism (PSM) based on the Institute of Electrical and Electronics Engineers (IEEE) 802.11 protocol, in order to solve a hidden node problem and allocate a channel in a multi-channel environment.

The contemporary wireless mesh network system using the MMAC protocol adopts a scheme where all nodes negotiate a channel using a common channel during a period of the ATIM window, and switch to the negotiated channel after termination of the ATIM window, and transmit data via the negotiated channel.

The contemporary wireless mesh network system using the MMAC protocol is advantageous in that each node uses a single interface and thus costs may be reduced and also the system is compatible with the existing IEEE 802.11 protocol. The conventional wireless mesh network system, however, is disadvantageous in that a relatively great overhead occurs due to the usage of the fixed ATIM window such as the PSM.

In the contemporary wireless mesh network system using the MMAC protocol, all nodes use the fixed ATIM with the same size for channel allocation. When the ATIM window is set to be relatively greater, it is impossible to transmit data during a period of the ATIM window, and thus a channel usage rate may deteriorate. Conversely, when the ATIM window is set to be relatively smaller, the channel allocation may fail, and thus the entire of one beacon interval may be wasted.

Also, the contemporary wireless mesh network system using the MMAC protocol uses a period of time corresponding to 20% of one beacon interval for channel negotiation. During the period of time, even a node that has completed the channel negotiation cannot transmit data. Therefore, in an aspect of the entire channel use rate, serious waste may occur.

Also, the conventional wireless mesh network system using the MMAC protocol is constructed to allocate the most excellent channel when selecting a data transmission channel in the ATIM window. In this instance, the most excellent channel may be determined based on a signal-to-noise ratio (SNR) and may be a channel with the strongest signal strength.

In this case, however, an aspect of “an amount of traffic to be transmitted during one beacon interval, that is, the size and number of packets” may be disregarded. Therefore, a relatively good channel may be allocated to a node with a relatively small amount of data, whereas a relatively poor channel may be allocated to a node with a relatively great amount of data. Therefore, when the relatively poor channel is allocated to the node with the relatively great amount of transmission data, packet loss may occur which is equal to the amount of data, which results in an increase in the number of retransmissions and also deterioration of the network performance.

### SUMMARY OF THE INVENTION

It is, therefore, one object of the present invention to provide an improved wireless mesh network system to solve the problems mentioned above and to improve network performance.

It is another object of the present invention to provide a wireless mesh network system in which an adaptive channel allocation is possible, which can dynamically change an Ad-hoc Traffic Indication Message (ATIM) window period for channel allocation through a channel negotiation process and thus improve network performance, and a channel allocation control method in the system.

It is another object of the present invention to provide a wireless mesh network system in which an adaptive channel allocation is possible, which can allocate an optimal channel to a node that transmits a relatively great amount of packets when allocating a channel and thus improve network performance, and a channel allocation control method in the system.

According to an aspect of the present invention, there is provided a channel allocation control method in a wireless mesh network system in which an adaptive channel allocation is possible, by using the steps of determining, by a receiving node, whether an Ad-hoc Traffic Indication Message (ATIM) packet is received from a transmission node during an ATIM window period after transmission of a beacon; determining, by the receiving node, whether a received point in time of the ATIM packet is a termination point in time of the ATIM window period when the ATIM Packet is received from the transmission node as a result of the determination; further setting, by the receiving node, an ATIM unit period for a channel negation time of a received node when the received point in time of the ATIM packet is the termination point in time of the ATIM window period as a result of the determination; and terminating, by the receiving node, the ATIM window after performing the channel negation with the transmission node that transmitted the ATIM packet.

The method may further include the steps of determining, by the receiving node, whether a period of time in which the ATIM packet is not received from the transmission node is greater than a predetermined no packet time (NPT) threshold, when the ATIM packet is not received from the transmission node as a result of the determination; determining, by the receiving node, whether a current point in time is greater than the termination point in time of the ATIM window period, when the period of time in which the ATIM packet is not received from the transmission node is less than or equal to the NPT threshold as a result of the determination; and waiting, by the receiving node, to the termination of point in time of the ATIM window, when the current point in time is less than or equal to the termination point in time of the ATIM window period as a result of the determination.

Also, the method may further include the step of terminating, by the receiving node, a current ATIM window either when the period of time in which the ATIM packet is not received from the transmission node is greater than the NPT threshold, or when the current point in time is greater than the termination point in time of the ATIM window period as a result of the determination.

Also, the step of determining whether the ATIM packet is received from the transmission node may include a minimum ATIM window period in which it is not determined whether the ATIM packet is received from the transmission node. The ATIM unit period may correspond to a minimum period of time in which it is possible to transmit an ATIM acknowledgment (ACK) and receive an ATIM response (RES).

According to another aspect of the present invention, there is provided a wireless mesh network system including at least one node in which an adaptive channel allocation is possible, with the system including a first determiner which determines whether an ATIM packet is received from a transmission node during an ATIM window period; a second determiner which determines whether a received point in time of the ATIM packet is a termination point in time of the ATIM window period; a unit period setting unit which further sets an ATIM unit period for a channel negation time of a received node when the received point in time of the ATIM packet is the termination point in time of the ATIM window period; and a channel setting unit which terminates the ATIM window after completing the channel negation with the transmission node that transmitted the ATIM packet.

The first determiner may determine whether a period of time in which the ATIM packet is not received from the transmission node is greater than a predetermined NPT threshold. When the period of time in which the ATIM packet is not received from the transmission node is less than or equal to the NPT threshold, the first determiner may determine whether a current point in time is greater than the termination point in time of the ATIM window period. When the current point in time is less than or equal to the termination point in time of the ATIM window period, the first determiner may be in an idle state by the termination point in time of the ATIM window period.

Also, either when the period of time in which the ATIM packet is not received from the transmission node is greater than the NPT threshold, or when the current point in time is greater than the termination point in time of the ATIM window period, the first determiner may terminate a current ATIM window. The first determiner may include a minimum ATIM window period in which it is not determined whether the ATIM packet is received from the transmission node.

Also, the ATIM unit period may correspond to a minimum period of time in which it is possible to transmit an ATIM ACK and receive an ATIM RES.

According to still another aspect of the present invention, there is provided a channel allocation control method in a wireless mesh network system in which an adaptive channel allocation is possible by updating, by a receiving node, a priority-based neighbor channel state (PNCS) table, wherein the PNCS table is generated by referring to a packet that is transmitted and received during an ATIM window period; calculating, by the receiving node, an expected transmission time (ETT) of an ATIM packet when the ATIM packet is received from a transmission node; and allocating, by the receiving node, a transmission/receiving channel based on comparison between the calculated expected transmission time and the PNCS table.

The PNCS table may include current channel information, priority information of an idle channel, common control channel information that supports a channel negotiation during the ATIM window period, and channel information about a channel that is available for an external node.

Also, the priority of the idle channel included in the PNCS table may divide a residual time of a beacon interval by the number of idle channels and assign a top channel priority to a node with a relatively greater expected transmission time.

Also, when the receiving node receives the ATIM packet from the transmission node, the expected transmission time may be calculated according to the following Equation (1),

$$ETT = {{Q}_{k = 1}}^{n} {ETT}_{k} = {{Q}_{k = 1}}^{n} {t}_{DATA , k} + n ( {t}_{RTS} + {t}_{CTS} + {t}_{ACK} + 3 SIFS ) , \qquad ( 1 )$$

where n denotes the number of pending packets, t_{DATA,k} denotes a transmission time for a data portion of a k^{th} packet, ETTₖ denotes an expected transmission time ETT of the k^{th} packet, and SIFS denotes a short interframe space.

According to yet another aspect of the present invention, there is provided a wireless mesh network system in which an adaptive channel allocation is possible, the system including: a PNCS manager which updates a PNCS table, in which the PNCS table is generated by referring to a packet that is transmitted and received during an ATIM window period; an ETT calculator which calculates an expected transmission time of an ATIM packet when the ATIM packet is received from a transmission node; and a channel allocator which allocates a transmission/receiving channel based on a comparison between the calculated expected transmission time of the packet and the PNCS table.

The PNCS table may include current channel information, priority information of an idle channel, common control channel information that supports a channel negotiation during the ATIM window period, and channel information about a channel that is available for an external node.

Also, the priority of the idle channel included in the PNCS table may divide a residual time of a beacon interval by the number of idle channels and assign a top channel priority to a node with a relatively greater expected transmission time.

Also, when the receiving node receives the ATIM packet from the transmission node, the expected transmission time may be calculated according to the following Equation (1),

$$ETT = {{Q}_{k = 1}}^{n} {ETT}_{k} = {{Q}_{k = 1}}^{n} {t}_{DATA , k} + n ( {t}_{RTS} + {t}_{CTS} + {t}_{ACK} + 3 SIFS ) \qquad ( 1 )$$

where n denotes the number of pending packets, t_{DATA,k} denotes a transmission time for a data portion of a k^{th} packet, ETTₖ denotes an expected transmission time ETT of the k^{th} packet, and SIFS denotes a short interframe space.

### BRIEF DESCRIPTION OF THE DRAWINGS

A more complete appreciation of the invention, and many of the attendant advantages thereof, will be readily apparent as the same becomes better understood by reference to the following detailed description, when considered in conjunction with the accompanying drawings, in which like reference symbols indicate the same or similar components, wherein:

FIG. 1 is a series of four, two-coordinate graphs that illustrate a channel negotiation process and a data exchange process in a multi-channel Medium Access Control (MMAC) constructed according to a contemporary art as a function of time;

FIG. 2 is a block diagram illustrating a configuration of a wireless mesh network system in which an adaptive channel allocation is possible constructed according to an exemplary embodiment of the present invention;

FIG. 3 is a block diagram illustrating a configuration of a wireless mesh network system in which an adaptive channel allocation is possible, which may be constructed as another exemplary embodiment of the present invention;

FIG. 4 illustrates an ETT in the wireless mesh network system in which the adaptive channel allocation is possible of FIG. 3;

FIG. 5 illustrates a channel allocation based on an amount of traffic in the wireless mesh network system in which the adaptive channel allocation is possible of FIG. 3;

FIG. 6 is a flowchart illustrating a channel allocation control method in a wireless mesh network system in which an adaptive channel allocation is possible, which may be constructed according to the exemplary embodiment of the present invention shown in FIG. 2; and

FIG. 7 is a flowchart illustrating a channel allocation control method in a wireless mesh network system in which an adaptive channel allocation is possible, which may be constructed according to another exemplary embodiment of the present invention shown in FIG. 3.

### DETAILED DESCRIPTION OF THE INVENTION

Reference will now be made in detail to exemplary embodiments of the present invention, examples of which are illustrated in the accompanying drawings, wherein like reference numerals refer to like elements throughout. Conventional art and exemplary embodiments are described below to explain the present invention with reference to the figures.

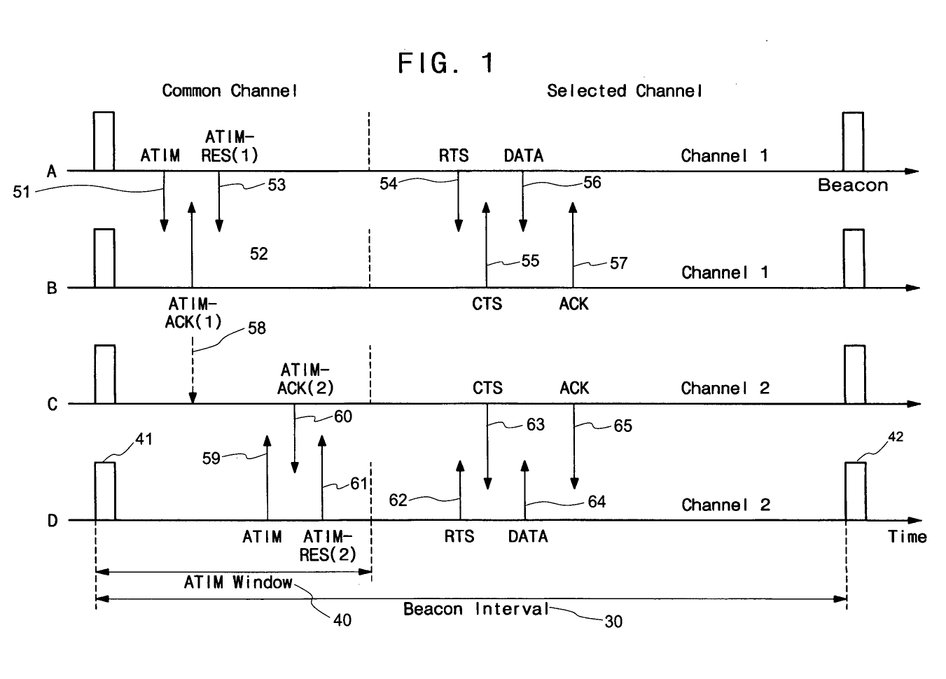

FIG. 1 illustrates a channel negotiation process and a data exchange process in a multi-channel Medium Access Control (MMAC) constructed according to a contemporary art;

The PSM divides a time at a predetermined beacon interval 30 (i.e. an interval between two beacons 41 and 42) as shown in FIG. 1, and includes a channel negotiation period of time every time each beacon interval starts. The channel negotiation period of time is referred to as an Ad-hoc Traffic Indication Message (ATIM) window 40. During the ATIM window, all nodes must be in an awake state.

A transmission node transmits data information to be transmitted to a receiving node as an ATIM packet. The receiving node responds as an ATIM-acknowledgment (ACK) packet. After termination of the ATIM window, only nodes that participate in data transmission communicate with each other in the awake state, and residual nodes are switched to a sleep state in which a packet 12 cannot be transmitted and received, thereby reducing overall energy consumption.

In the ATIM window, for channel 1, a transmission node A transmits an ATIM packet 51, receiving node B responds an ATIM-ACK (1) packet 52, and then transmission node A receives an ATIM response (RES) packet 53. In the ATIM window, for channel 2, a transmission node D transmits an ATIM packet 59, a receiving node C responds an ATIM-ACK (21) packet 60, and then transmission node D receives an ATIM-RES(2) packet 61. The packets transmission on channel 2 is later the packets transmission on channel 1. In other words, the time position of transmission of ATIM packet 59 is later than the time position of the transmission of ATIM-ACK(1) packet respect to receiving node C, i.e., a time position 58. After the ATIM window terminates, for channel 1, transmission node A transmits a request to send (RTS) packet 54, receiving node B responds a clear to send (CTS) 55, and transmission node A transmits data packet 56, then receiving node B responds an acknowledge (ACK) packet 57. In the same time period, for channel 2, transmission node D transmits a request to send (RTS) packet 62, receiving node C responds to a clear to send (CTS) 63, and transmission node D transmits data packet 64, then receiving node C responds an acknowledge (ACK) packet 65.

The conventional wireless mesh network system using the MMAC protocol adopts a scheme where all nodes negotiate a channel using a common channel during a period of the ATIM window, and switch to the negotiated channel after termination of the ATIM window, and transmit data via the negotiated channel.

The conventional wireless mesh network system using the MMAC protocol is advantageous in that each node uses a single interface and thus costs may be reduced and also the system is compatible with the existing IEEE 802.11 protocol. The conventional wireless mesh network system, however, is disadvantageous in that a relatively great overhead occurs due to the usage of the fixed ATIM window such as the PSM.

In the conventional wireless mesh network system using the MMAC protocol, all nodes use the fixed ATIM with the same size for channel allocation. When the ATIM window is set to be relatively greater, it is impossible to transmit data during a period of the ATIM window, and thus a channel usage rate may be deteriorated. Conversely, when the ATIM window is set to be relatively smaller, the channel allocation may fail, and thus the entire of one beacon interval may be wasted.

Also, the conventional wireless mesh network system using the MMAC protocol uses a period of time corresponding to 20% of one beacon interval for channel negotiation. During the period of time, even a node that has completed the channel negotiation cannot transmit data. Therefore, in an aspect of the entire channel use rate, serious waste may occur.

Also, the conventional wireless mesh network system using the MMAC protocol is constructed to allocate the most excellent channel when selecting a data transmission channel in the ATIM window. In this instance, the most excellent channel may be determined based on a signal-to-noise ratio (SNR) and may be a channel with the strongest signal strength.

In this case, however, an aspect of “an amount of traffic to be transmitted during one beacon interval, that is, the size and number of packets” may be disregarded. Therefore, a relatively good channel may be allocated to a node with a relatively small amount of data, whereas a relatively poor channel may be allocated to a node with a relatively great amount of data. Therefore, when the relatively poor channel is allocated to the node with the relatively great amount of transmission data, packet loss may occur equal to the amount of data, which results in an increase in the number of re-transmissions and also deterioration of the network performance.

A system configuration to be described later is adopted for concise description of the present invention and thus it will be understood by those of ordinary skill in the art that the present invention is not limited thereto.

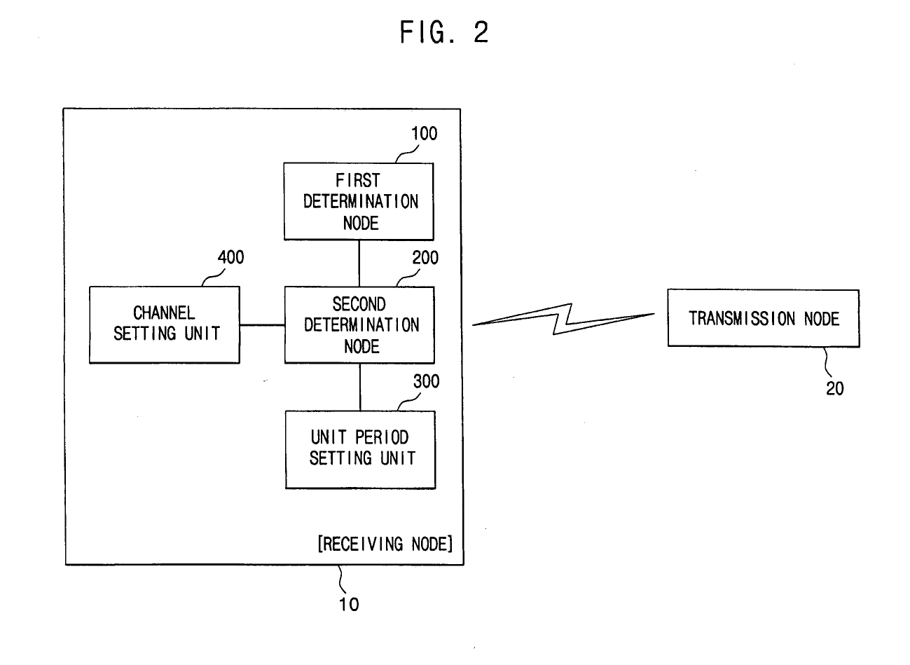

FIG. 2 is a block diagram illustrating a configuration of a wireless mesh network system in which an adaptive channel allocation is possible constructed according to an exemplary embodiment of the present invention. In the wireless mesh network system in which the adaptive channel allocation is possible according to the present exemplary embodiment, each node includes a first determiner 100, a second determiner 200, a unit period setting unit 300, and a channel setting unit 400. In other words, both receiving node 10 and transmission node 20 includes a first determiner 100, a second determiner 200, a unit period setting unit 300, and a channel setting unit 400.

First determiner 100 determines whether an Ad-hoc Traffic Indication Message (ATIM) packet is received from a transmission node 20 during an ATIM window period. In this instance, first determiner 100 determines whether a period of time in which the ATIM packet is not received from transmission node 20 is greater than a predetermined no packet time (NPT) threshold. When the period of time in which the ATIM packet is not received from the transmission node is less than or equal to the NPT threshold, first determiner 100 determines whether a current point in time is greater than a termination point in time of the ATIM window period. Also, when the current point in time is less than or equal to the termination point in time of the ATIM window period, first determiner 100 is in an idle state by the termination point in time of the ATIM window period.

Conversely, either when the period of time in which the ATIM packet is not received from transmission node 20 is greater than the NPT threshold, or when the current point in time is greater than the termination point in time of the ATIM window period, first determiner 100 terminates a current ATIM window. Also, first determiner 100 includes a minimum ATIM window period in which it is not determined whether the ATIM packet is received from transmission node 20.

Second determiner 200 determines whether a point in time that the ATIM packet is received from transmission node 20 is the termination point in time of the ATIM window period. The termination point in time of the ATIM window period denotes a period in which receiving node 10 cannot transmit an ATIM acknowledgment (ACK), or a period in which even though receiving node 10 transmits the ATIM ACK, receiving node 10 may not receive an ATIM response (RES) from transmission node 20.

When the received point in time of the ATIM packet is the termination point in time of the ATIM window period, unit period setting unit 300 further sets an ATIM unit period for a channel negation time of a received node. The ATIM unit period corresponds to a minimum period of time in which it is possible to transmit the ATIM ACK and receive the ATIM RES.

Channel setting unit 400 terminates the ATIM window after completing the channel negation with the transmission node 20 that transmitted the ATIM packet.

Descriptions related to general functions of each of components and detailed operations thereof will be omitted. Hereinafter, operations corresponding to the present exemplary embodiment will be described.

The wireless mesh network includes at least one node. The at least one node performs communication via a multi-channel. Also, the at least one node must go through a channel negotiation process and a data exchange process of a multi-channel Medium Access Control (MMAC) protocol.

Generally, after receiving node 10 transmits a beacon signal and makes a channel negotiation with transmission node 20 for the ATIM window period, a transmission/receiving channel may be determined.

First determiner 100 of receiving node 10 may determine whether the ATIM packet is received from any random transmission node 20 during the ATIM window period.

When the ATIM packet is received from random transmission node 20, second determiner 200 of receiving node 10 may determine whether the received point time of the ATIM packet is the termination point in time of the ATIM window period.

When the received point in time of the ATIM packet is the termination point in time of the ATIM window period, unit period setting unit 300 of receiving node 10 may further set the ATIM unit period for the channel negotiation time of the received node. Specifically, unit period setting unit 300 may extend the ATIM window period by as long as the ATIM unit period.

Channel setting unit 400 may terminate the ATIM window after completing the channel negotiation with transmission node 20 that transmitted the ATIM packet. Specifically, the channel negotiation may be terminated in such a manner that receiving node 10 transmits the ATIM ACK to transmission node 20 having transmitted the ATIM packet and receives the ATIM RES from transmission node 20.

In this instance, first determiner 100 may include a minimum ATIM window period in which it is not determined whether the ATIM packet is received from transmission node 20.

In the meantime, first determiner 100 may determine whether a period of time in which the ATIM packet is not received from transmission node 20 is greater than a predetermined NPT threshold.

In this case, when the period of time in which the ATIM packet is not received from transmission node 20 is less than or equal to the NPT threshold, first determiner 100 may determine whether a current point in time is greater than the termination point in time of the ATIM window period. When the current point in time is less than or equal to the termination point in time of the ATIM window period, first determiner 100 may be in an idle state by the termination point in time of the ATIM window period.

Specifically, receiving node 10 may determine the ATIM packet is not received from transmission node 20 and may be in the idle state by a next beacon interval without transmitting and receiving the ATIM packet during a current beacon interval.

Conversely, either when the period of time in which the ATIM packet is not received from transmission node 20 is greater than the NPT threshold, or when the current point in time is greater than the termination point in time of the ATIM window period, first determiner 100 may terminate a current ATIM window. Specifically, first determiner 100 may determine the ATIM packet is not received from transmission node 20 and may be in the idle state by the next beacon interval without transmitting and receiving the ATIM packet during the current beacon interval.

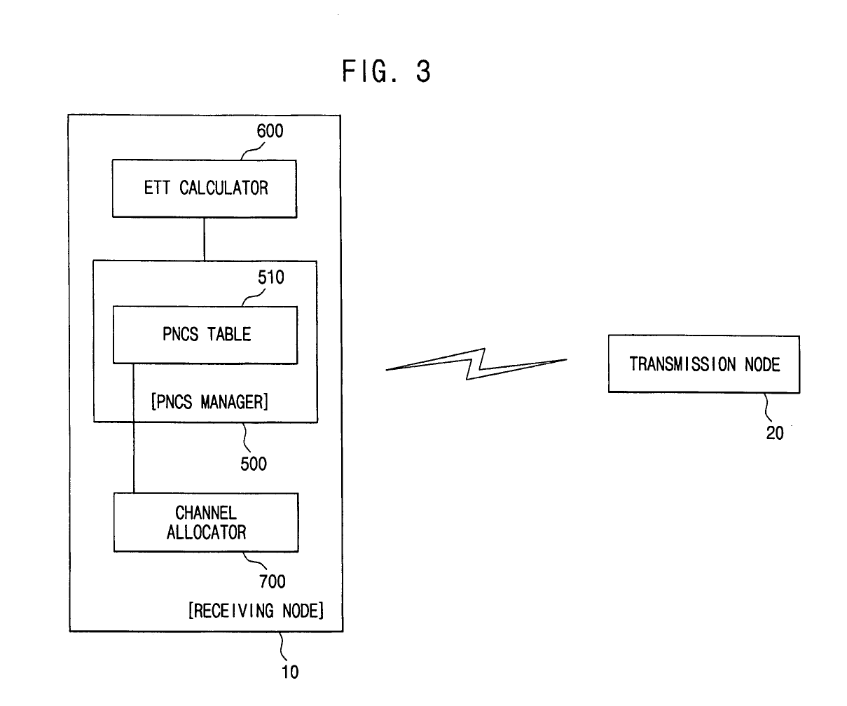

FIG. 3 is a block diagram illustrating a configuration of a wireless mesh network system in which an adaptive channel allocation is possible constructed according to another exemplary embodiment of the present invention. In the wireless mesh network system in which the adaptive channel allocation is possible constructed according to the present exemplary embodiment, each node includes a priority-based neighbor channel state (PNCS) manager 500, an expected transmission time (ETT) calculator 600, and a channel allocator 700. The node may further include a PNCS table 510.

PNCS manager 500 updates PNCS table 510. PNCS table 510 is generated by referring to a packet that is transmitted and received during an ATIM window period. PNCS table 510 includes current channel information, priority information of an idle channel, common control channel information that supports a channel negotiation during the ATIM window period, and channel information about a channel that is available for an external node, as shown in Table 1 below. The priority of the idle channel included in the PNCS table divides a residual time of a beacon interval by the number of idle channels and assigns a top channel priority to a node with a relatively greater expected transmission time.

TABLE 1

| Current channel | | Channel Number |
|---|---|---|
| Idle channel | 1 | 4 |
| | 2 | 5 |
| | . . . | . . . |
| | n | n + 3 |

| | |
|---|---|
| Control channel | 1 |
| Busy channel | 2, 3 |

When the ATIM packet is received from transmission node 20, ETT calculator 600 calculates the expected transmission time according to the following Equation (1),

$$ETT = {{Q}_{k = 1}}^{n} {ETT}_{k} = {{Q}_{k = 1}}^{n} {t}_{DATA , k} + n ( {t}_{RTS} + {t}_{CTS} + {t}_{ACK} + 3 SIFS ) , \qquad ( 1 )$$

where n denotes the number of pending packets, t_{DATA,k} denotes a transmission time for a data portion of a k^{th} packet, ETTₖ denotes an expected transmission time ETT of the k^{th} packet, and SIFS denotes a short interframe space.

Also, channel allocator 700 allocates a transmission/receiving channel based on comparison between the calculated expected transmission time and PNCS table 510.

Descriptions related to general functions of each of components and detailed operations thereof will be omitted. Hereinafter, operations corresponding to the present exemplary embodiment will be described.

Receiving node 10 and transmission node 20 may advance a channel negotiation during the ATIM window period and thereby allocate a channel.

In this instance, PNCS manager 500 of receiving node 10 may update PNCS table 510 that is generated by referring to a packet that is transmitted and receiving during the ATIM window period.

Specifically, when receiving node 10 receives the ATIM packet from transmission node 20 via a common channel during the ATIM window period, receiving node 10 may transmit the ATIM ACK to transmission node 20 and receives the ATIM RES packet from transmission node 20. Through the above operation, the channel negotiation and the channel allocation may be performed.

As shown in Table 1, PNCS table 510 that is updated by PNCS manager 500 of receiving unit 10 includes a current channel, an idle channel, a control channel, and a busy channel. The current channel denotes a channel that is already allocated by receiving node 10 and transmission node 20 for transmission during a current beacon interval. The idle channel denotes a channel that is not yet used within the transmission range. The control channel denotes a channel that is used during a channel allocation time, called the ATIM window, when the beacon interval starts. The busy channel denotes a channel that is used by a neighbor node within the transmission range.

In this instance, idle channel of PNCS table 510 has a priority. The priority determination criterion of the priority divides a residual time of the beacon interval by the number of idle channels and assigns a top channel priority to a node with greater expected transmission time.

Specifically, when the ATIM packet is received from transmission node 20, ETT calculator 600 of receiving node 10 calculates the expected transmission time according to the following 4 Equation (1):

$$ETT = {{Q}_{k = 1}}^{n} {ETT}_{k} = {{Q}_{k = 1}}^{n} {t}_{DATA , k} + n ( {t}_{RTS} + {t}_{CTS} + {t}_{ACK} + 3 SIFS ) , \qquad ( 1 )$$

where n denotes the number of pending packets, t_{DATA,k} denotes a transmission time for a data portion of a k^{th} packet, ETTₖ denotes an expected transmission time ETT of the k^{th} packet, and SIFS denotes a short interframe space.

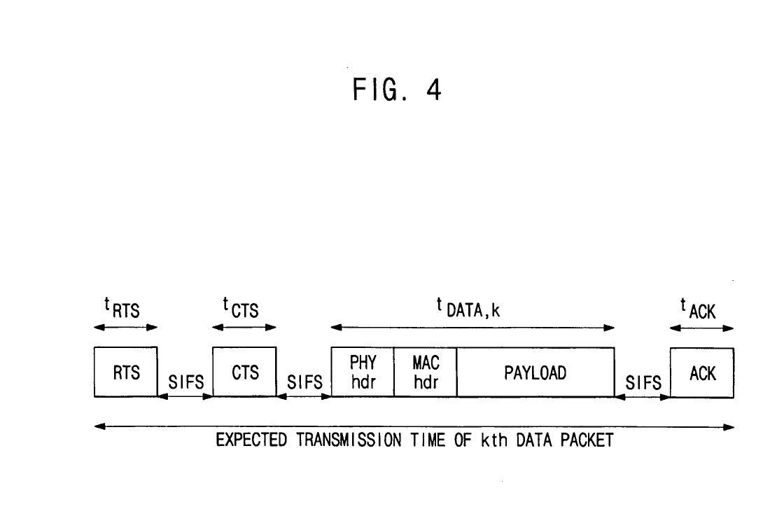

An example of the expected transmission time ETT is shown in FIG. 4. As shown in FIG. 4, ETTₖ, i.e., the expected transmission time ETT of the k^{th} packet is equal to the summary of one time period of t_{DATA,k} (transmission time for a data portion of a k^{th} packet), three time periods of SIFS, one time period of t_{RTS} (request to send), one time period of t_{CTS} (clear to send) and one time period of t_{ACK} (acknowledgment). SIFS denotes for short interframe space and S refers to waiting time excluding data transmission. The total expected transmission time ETT is the summary of the transmission time of all of the transmitted packets. Accordingly, channel allocator 700 of transmission node 20 compares the expected transmission time, which is calculated by ETT calculator 600, with PNCS table 510 and allocates a transmission and receiving channel based on this comparison.

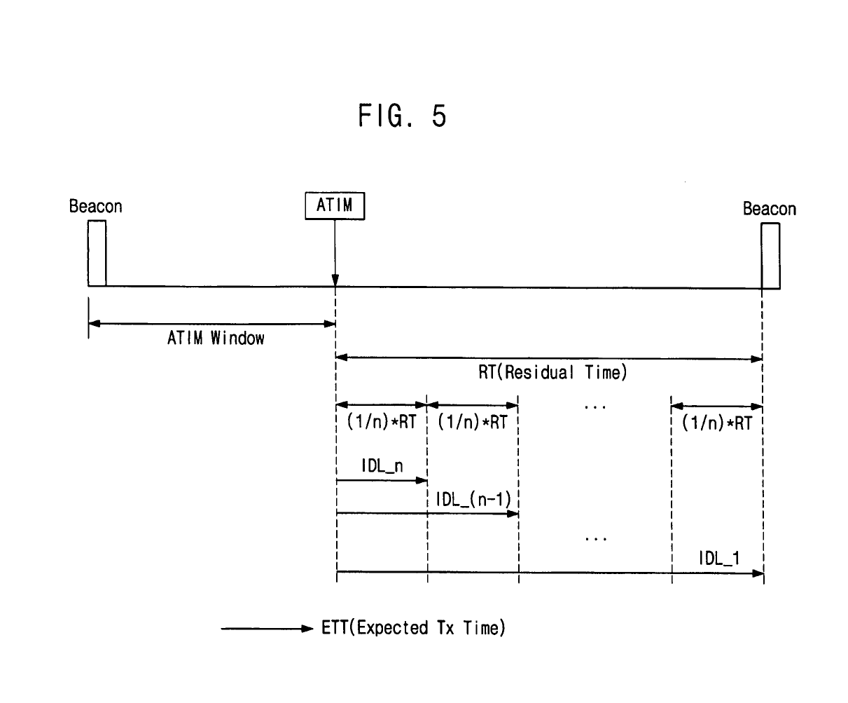

Specifically, as shown in FIG. 5, in the expected transmission time calculated by ETT calculator 600, when the packet size is relatively large, for example IDL_{—}1, channel allocator 700 allocates a channel 4 with the most excellent channel state among the idle channels. Conversely, when the packet size is relatively small, for example IDL_n, channel allocator 700 allocates a channel n+3 with the poorest channel state.

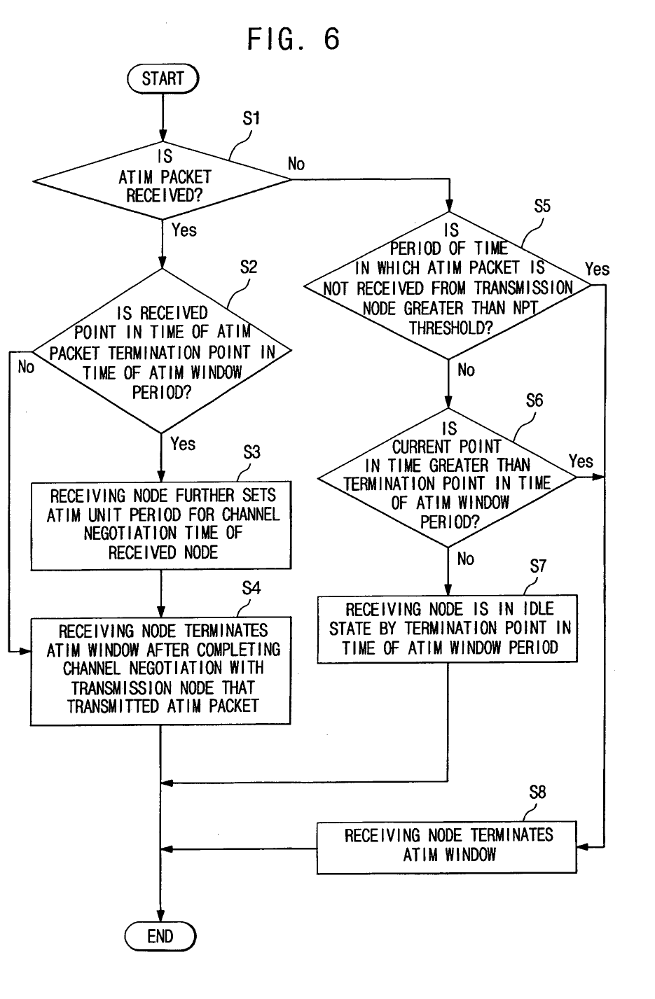

Hereinafter, a channel allocation control method in a wireless mesh network system in which an adaptive channel allocation is possible constructed according to an exemplary embodiment of the present invention as shown in FIG. 2, constructed as above, will be described with reference to FIG. 6.

In step S1, receiving node 10 determines whether an ATIM packet is received from transmission node 20 during an ATIM window period after transmission of a beacon. According to an aspect of the present invention, step S1 may include a minimum ATIM window period in which it is not determined whether the ATIM packet is received from transmission node 20.

In step S2, when the ATIM packet is received from transmission node 20, that is, when it is a yes instruction in step S1, receiving node 10 determines whether a received point in time of the ATIM packet is a termination point in time of the ATIM window time period.

In step S3, when the received point in time of the ATIM packet is the termination point in time of the ATIM window period, that is, when it is a yes instruction in step S2, receiving node 10 further sets an ATIM unit period for a channel negotiation time of a received node. The ATIM unit period corresponds to a minimum period of time in which it is possible to transmit an ATIM ACK packet and receive an ATIM RES packet.

In step S4, receiving node 10 terminates the ATIM window after completing the channel negotiation with transmission node 20 that transmitted the ATIM packet.

Conversely, when the ATIM packet is not received from transmission node 20, that is, when it is a no instruction in step S1, receiving node 10 determines whether a period of time in which the ATIM packet is not received from the transmission node is greater than a predetermined NPT threshold in step S5.

In step S6, when the period of time in which the ATIM packet is not received from the transmission node is less than or equal to the NPT threshold, that is, when it is a no instruction in step S5, receiving node 10 determines whether a current point in time is greater than the termination point in time of the ATIM window period.

In step S7, when the current point in time is less than or equal to the termination point in time of the ATIM window period, that is, when it is a NO instruction in step S6, receiving node 10 is in an idle state by the point in time of the ATIM window.

Conversely, when the period of time in which the ATIM packet is not received from transmission node 20 is greater than the NPT in step S5, or when the current point in time is greater than the termination point in time of the ATIM window period in step S6, receiving node 10 terminates the current ATIM window in step S8.

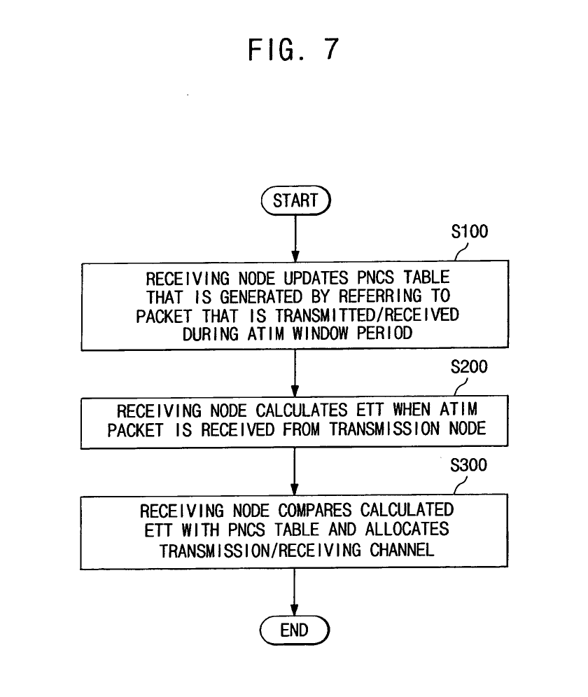

Hereinafter, a channel allocation control method in a wireless mesh network system in which an adaptive channel allocation is possible according to another exemplary embodiment of the present invention as shown in FIG. 3, constructed as above, will be described with reference to FIG. 7.

In step S100, receiving node 10 updates a PNCS table that is generated by referring to a packet that is transmitted and received during an ATIM window period. The PNCS table includes current channel information, priority information of an idle channel, common control channel information that supports a channel negotiation during the ATIM window period, and channel information about a channel that is available for an external node. The priority of the idle channel included in the PNCS table divides a residual time of a beacon interval by the number of idle channels and assigns a top channel priority to a node with a relatively greater expected transmission time.

In step S200, receiving node 10 that receives the ATIM packet from the transmission node 20 calculates the expected transmission time of the ATIM packet. When receiving node 10 receives the ATIM packet from transmission node 20, the expected transmission time ETT is calculated according to the following Equation (1),

$$ETT = {{Q}_{k = 1}}^{n} {ETT}_{k} = {{Q}_{k = 1}}^{n} {t}_{DATA , k} + n ( {t}_{RTS} + {t}_{CTS} + {t}_{ACK} + 3 SIFS ) , \qquad ( 1 )$$

where n denotes the number of pending packets, t_{DATA,k} denotes a transmission time for a data portion of a k^{th} packet, ETTₖ denotes an expected transmission time ETT of the k^{th} packet, and SIFS denotes a short interframe space.

In step S300, receiving node 10 compares the calculated expected transmission time ETT with the PNCS table and allocates a transmission/receiving channel based on the comparison.

As described above, according to the present invention, a wireless mesh network system in which an adaptive channel allocation is possible and a channel allocation control method in the system may significantly improve packet transmission efficiency.

Although a few exemplary embodiments of the present invention have been shown and described, the present invention is not limited to the described exemplary embodiments. Instead, it will be appreciated by those skilled in the art that changes may be made to the exemplary embodiments herein without departing from the principles and spirit of the invention, the scope of which is defined by the following claims and their equivalents.

1. A channel allocation control method, the method comprising the steps of:
determining, in a wireless mesh network system including at least one node in which an adaptive channel allocation is possible, at a receiving node, whether an Ad-hoc Traffic Indication Message (ATIM) packet is received from a transmission node during an ATIM window period after transmission of a beacon;
determining, at the receiving node, whether a received point in time of the ATIM packet is a termination point in time of the ATIM window period when the ATIM Packet is received from the transmission node as a result of the determination;
further setting, at the receiving node, an ATIM unit period for a channel negation time of a received node when the received point in time of the ATIM packet is the termination point in time of the ATIM window period as a result of the determination; and
terminating, at the receiving node, the ATIM window after performing the channel negation with the transmission node that transmitted the ATIM packet.

2. The method of claim 1, further comprising the steps of:
determining, at the receiving node, whether a period of time in which the ATIM packet is not received from the transmission node is greater than a predetermined no packet time (NPT) threshold, when the ATIM packet is not received from the transmission node as a result of the determination;
determining, by the receiving node, whether a current point in time is greater than the termination point in time of the ATIM window period, when the period of time in which the ATIM packet is not received from the transmission node is less than or equal to the NPT threshold as a result of the determination; and
waiting, at the receiving node, to the termination of point in time of the ATIM window, when the current point in time is less than or equal to the termination point in time of the ATIM window period as a result of the determination.

3. The method of claim 2, further comprising the step of:
terminating, at the receiving node, a current ATIM window either when the period of time in which the ATIM packet is not received from the transmission node is greater than the NPT threshold, or when the current point in time is greater than the termination point in time of the ATIM window period as a result of the determination.

4. The method of claim 1, wherein the step of determining whether the ATIM packet is received from the transmission node comprises a minimum ATIM window period in which it is not determined whether the ATIM packet is received from the transmission node.

5. The method of claim 1, wherein the ATIM unit period corresponds to a minimum period of time in which it is possible to transmit an ATIM acknowledgment (ACK) and receive an ATIM response (RES).

6. A channel allocation control method in a wireless mesh network system including at last one node in which an adaptive channel allocation is possible, the method comprising the steps of:
updating, at a receiving node, a priority-based neighbor channel state (PNCS) table, wherein the PNCS table is generated by referring to a packet that is transmitted and received during an ATIM window period;
calculating, at the receiving node, an expected transmission time (ETT) of an ATIM packet when the ATIM packet is received from a transmission node; and
allocating, at the receiving node, a transmission and a receiving channel based on comparison between the calculated expected transmission time and the PNCS table.

7. The method of claim 6, wherein the PNCS table comprises current channel information, priority information of an idle channel, common control channel information that supports a channel negotiation during the ATIM window period, and channel information about a channel that is available for an external node.

8. The method of claim 7, wherein the priority of the idle channel included in the PNCS table divides a residual time (RT) of a beacon interval by the number of idle channels and assigns a top channel priority to a node with a relatively greater expected transmission time.

9. The method of claim 6, wherein when the receiving node receives the ATIM packet from the transmission node, the expected transmission time is calculated according to the following equation:
$$ETT = {{Q}_{k = 1}}^{n} {ETT}_{k} = {{Q}_{k = 1}}^{n} {t}_{DATA , k} + n ( {t}_{RTS} + {t}_{CTS} + {t}_{ACK} + 3 SIFS ) ,$$
where n denotes the number of pending packets, t_{DATA,k} denotes a transmission time for a data portion of a k^{th} packet, ETTₖ denotes an expected transmission time ETT of the k^{th} packet, and SIFS denotes a short interframe space.

10. A wireless mesh network system including at least one node in which an adaptive channel allocation is possible, the system comprising:
a first determiner which determines whether an ATIM packet is received from a transmission node during an ATIM window period;
a second determiner which determines whether a received point in time of the ATIM packet is a termination point in time of the ATIM window period;
a unit period setting unit which further sets an ATIM unit period for a channel negation time of a received node when the received point in time of the ATIM packet is the termination point in time of the ATIM window period; and
a channel setting unit which terminates the ATIM window after completing the channel negation with the transmission node that transmitted the ATIM packet.

11. The system of claim 10, wherein the first determiner determines whether a period of time in which the ATIM packet is not received from the transmission node is greater than a predetermined NPT threshold, and determines whether a current point in time is greater than the termination point in time of the ATIM window period when the period of time in which the ATIM packet is not received from the transmission node is less than or equal to the NPT threshold.

12. The system of claim 11, wherein the first determiner is in an idle state by the termination point in time of the ATIM window period when the current point in time is less than or equal to the termination point in time of the ATIM window period.

13. The system of claim 12, wherein the first determiner terminates a current ATIM window either when the period of time in which the ATIM packet is not received from the transmission node is greater than the NPT threshold, or when the current point in time is greater than the termination point in time of the ATIM window period.

14. The system of claim 11, wherein the first determiner comprises a minimum ATIM window period in which it is not determined whether the ATIM packet is received from the transmission node.

15. The system of claim 14, wherein the ATIM unit period corresponds to a minimum period of time in which it is possible to transmit an ATIM ACK and receive an ATIM RES.

16. A wireless mesh network system including at least one node in which an adaptive channel allocation is possible, the system comprising:
a PNCS manager which updates a PNCS table, wherein the PNCS table is generated by referring to a packet that is transmitted and received during an ATIM window period;
an ETT calculator which calculates an expected transmission time of an ATIM packet when the ATIM packet is received from a transmission node; and
a channel allocator which allocates a transmission/receiving channel based on a comparison between the calculated expected transmission time of the packet and the PNCS table.

17. The system of claim 16, wherein the PNCS table comprises current channel information, priority information of an idle channel, common control channel information that supports a channel negotiation during the ATIM window period, and channel information about a channel that is available for an external node.

18. The system of claim 17, wherein the priority of the idle channel included in the PNCS table divides a residual time of a beacon interval by the number of idle channels and assigns a top channel priority to a node with a relatively greater expected transmission time.

19. The system of claim 16, wherein when the receiving node receives the ATIM packet from the transmission node, the expected transmission time is calculated according to the following equation:
$$ETT = {{Q}_{k = 1}}^{n} {ETT}_{k} = {{Q}_{k = 1}}^{n} {t}_{DATA , k} + n ( {t}_{RTS} + {t}_{CTS} + {t}_{ACK} + 3 SIFS ) , \qquad$$
where n denotes the number of pending packets, t_{DATA,k} denotes a transmission time for a data portion of a k^{th} packet, ETTₖ denotes an expected transmission time ETT of the k^{th} packet, and SIFS denotes a short interframe space.

20. A channel allocation control method in a wireless mesh network system including at least one node in which an adaptive channel allocation is possible, the method comprising the steps of:
determining, at a receiving node, whether an Ad-hoc Traffic Indication Message (ATIM) packet is received from a transmission node;
when an Ad-hoc Traffic Indication Message (ATIM) packet is received from the transmission node, determining, at the receiving node, whether a received point in time of the ATIM packet is a termination point in time of the ATIM window period when the ATIM Packet is received from the transmission node as a result of the determination;
when an Ad-hoc Traffic Indication Message (ATIM) packet is not received from the transmission node, determining, at the receiving node, whether a period of time in which the ATIM packet is not received from the transmission node is greater than a predetermined a no packet time (NPT) threshold;
when the period of time in which is ATIM is not received from the transmission node is less than or equal to the no packet time (NPT) threshold, determining, at the receiving node, whether a current point in time is greater than the termination point in time of the ATIM window period;
when an Ad-hoc Traffic Indication Message (ATIM) packet is not received from the transmission node, and either when the period of time in which the ATIM packet is not received from the transmission node is greater than the no packet time (NPT) threshold or when the current point in time is greater than the terminating point in time of the ATIM window period, terminating, by the receiving node, the current ATIM window;
when an Ad-hoc Traffic Indication Message (ATIM) packet is received from the transmission node and when the received point in time of the ATIM packet is the termination point time of the ATIM window time period, setting, at the receiving node, an ATIM unit period for a channel negation time of a received node when the received point in time of the ATIM packet is the termination point in time of the ATIM window period as a result of the determination, and terminating, by the receiving node, the ATIM window after completing the channel negotiation with the transmission node that transmitted the ATIM packet;
either when an Ad-hoc Traffic Indication Message (ATIM) packet is received from the transmission node and the received point in time of the ATIM packet is not the termination point time of the ATIM window time period, terminating, at the receiving node, the ATIM window after completing the channel negotiation with the transmission node that transmitted the ATIM packet; and
when an Ad-hoc Traffic Indication Message (ATIM) packet is not received from the transmission node, and when the period of time in which the ATIM packet is not received from the transmission node is not greater than the no packet time (NPT) threshold and the current point in time is less than or equal to the terminating point in time of the ATIM window period, setting the receiving node in an idle state by the point in time of the ATIM window.
